(19) United States
(12) Patent Application Publication
(10) Pub. No.: US 2025/0072510 A1
(43) Pub. Date: Mar. 6, 2025

(54) VAPORIZER AND AEROSOL GENERATING DEVICE INCLUDING THE SAME

(71) Applicant: KT & G CORPORATION, Daejeon (KR)

(72) Inventors: Sung Wook YOON, Gyeonggi-do (KR); Tae Hun KIM, Gyeonggi-do (KR); Ju Eon PARK, Gyeonggi-do (KR); Hyung Jin JUNG, Seoul (KR); Jung Ho HAN, Daejeon (KR)

(73) Assignee: KT & G CORPORATION, Daejeon (KR)

(21) Appl. No.: 18/561,533

(22) PCT Filed: Aug. 8, 2023
(86) PCT No.: PCT/KR2023/011655

§ 371 Date: Nov. 16, 2023

(30) Foreign Application Priority Data
Aug. 8, 2022 (KR) 10-2022-0098781
Nov. 25, 2022 (KR) 10-2022-0160790

(51) Int. Cl. A24F 40/485; A24F 40/10; A24F 40/20; A24F 40/30; A24F 40/44; A24F 40/46; A24F 40/51; A24F 40/65; A24F 40/95

(52) U.S. Cl. CPC A24F 40/485; A24F 40/46; A24F 40/10; A24F 40/20; A24F 40/30; A24F 40/44; A24F 40/51; A24F 40/65; A24F 40/95

(57) ABSTRACT

Provided is a vaporizer including a storage for storing an aerosol generating material, a generator configured to generate an aerosol from the aerosol generating material, and an accommodating unit including a chamber configured to accommodate the generator, and an inlet configured to introduce air into the chamber, wherein the accommodating unit includes a plurality of walls surrounding the chamber, and at least some of the plurality of walls include an inclined surface.

### TECHNICAL FIELD

Embodiments relate to a vaporizer and an aerosol generating device including the vaporizer, and more particularly, to a vaporizer having improved atomization performance and an aerosol generating device including the vaporizer.

### BACKGROUND ART

Recently, the demand for alternative methods to overcome the disadvantages of traditional cigarettes has increased.

Recently, an aerosol generating apparatus that may generate an aerosol by heating an aerosol generating article has been suggested as a way to replace a method of supplying an aerosol by burning cigarettes. The aerosol generating apparatus may be, for example, an apparatus capable of generating an aerosol by heating an aerosol generating material in a liquid or solid state through a heater to a predetermined temperature.

When an aerosol generating apparatus is used, smoking can be performed without additional supplies such as a lighter, and a user's smoking convenience can be enhanced as a user can smoke as much as he/she wants. Thus, research on aerosol generating apparatuses has gradually increased.

When an aerosol generating device including a vaporizer is used, air outside the aerosol generating device is introduced into the vaporizer and an airflow including an aerosol generated in the vaporizer is delivered to a user's mouth.

To increase the speed of the airflow and improve the amount of smoke, the structure of a portion where an airflow path is formed in the aerosol generating device needs to be improved. A goal of the improvement of the structure is to remove a dead zone where the airflow is not formed, thereby ensuring that the airflow is formed smoothly without turbulence.

Meanwhile, in the processes of producing a product, the structure of the components needs to be simple to automate the assembly process of the components. That is, in the manufacturing process before going through the assembly process, the structure of a mold used for the manufacture of subcomponents of a product needs to be simplified.

In the field of aerosol generating devices, vaporizers are usually used as consumables. The necessity of mass production of vaporizers used as consumables is greater than that of the main body of an aerosol generating device. The necessity of mass production is related to the automation of the assembly process and simplification of the mold structure, in view of the production of the product.

Therefore, there is a need for an improved internal structure of the vaporizer while keeping the structure of the mold simple.

### DISCLOSURE OF INVENTION

### Technical Problem

Provided are a vaporizer having improved structure for airflow in the vaporizer to be proceeded smoothly and an aerosol generating device including the vaporizer.

Objects to be achieved by the embodiments are not limited to the above-described objects, and objects not described may be clearly understood by those skilled in the art to which the embodiments belong from the present specification and the accompanying drawings.

### Solution to Problem

According to one or more embodiments, a vaporizer includes a storage for storing an aerosol generating material, a generator configured to generate an aerosol from the aerosol generating material, and an accommodating unit including a chamber configured to accommodate the generator, and an inlet configured to introduce air into the chamber, wherein the accommodating unit includes a plurality of walls surrounding the chamber, and at least some of the plurality of walls include an inclined surface.

In an embodiment, an aerosol generating device may include the above-described vaporizer, a main body including an accommodating space configured to accommodate an aerosol generating article and connected to the vaporizer, a heater configured to heat the aerosol generating article accommodated in the main body, a battery configured to supply power to the generator and the heater, and a controller configured to control power supplied to the generator and the heater.

### Advantageous Effects of Invention

According to a vaporizer and an aerosol generating device including the vaporizer, turbulence may be prevented from being generated in the vaporizer.

In addition, according to the vaporizer and the aerosol generating device including the vaporizer, an amount of smoke may be increased due to smooth processing of an airflow.

The effects according to one or embodiments are not limited to the effects described above, and unmentioned effects will be clearly understood by one of ordinary skill in the art from the present specification and the accompanying drawings.

### BRIEF DESCRIPTION OF DRAWINGS

FIG. 1 is a view of an example of an aerosol generating device including a vaporizer, according to an embodiment;

FIG. 2 is a side view schematically illustrating the exterior of an aerosol generating device according to an embodiment;

FIG. 3 is an exploded perspective view of a vaporizer according to an embodiment;

FIG. 4 is a side cross-sectional view of a vaporizer according to an embodiment;

FIGS. 5A to 5F are each a perspective cross-sectional view of an accommodating unit of a vaporizer according to another embodiment;

FIGS. 6A and 6B are each a side sectional view of an accommodating unit of a vaporizer according to another embodiment;

FIG. 7 is a side cross-sectional view of an accommodating unit of a vaporizer according to another embodiment;

FIGS. 8A and 8B are each a side cross-sectional view of an accommodating unit of a vaporizer according to another embodiment; and

FIG. 9 is a block diagram of an aerosol generating device according to another embodiment.

### MODE FOR THE INVENTION

With respect to the terms used to describe, in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, a term which is not commonly used can be selected. In such a case, the meaning of the term will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, when an expression such as “at least any one” precedes arranged elements, it modifies all elements rather than each arranged element. For example, the expression, “at least one of a, b, and c,” should be understood as including only a, only b, only c, both a and b, both a and c, both b and, or all of a, b, and c.

In an embodiment, an aerosol generating device may be a device that generates aerosols by electrically heating a cigarette accommodated in an interior space thereof.

The aerosol generating device may include a heater. In an embodiment, the heater may be an electro-resistive heater. For example, the heater may include an electrically conductive track, and the heater may be heated when currents flow through the electrically conductive track.

The heater may include a tube-shaped heating element, a plate-shaped heating element, a needle-shaped heating element, or a rod-shaped heating element, and may heat the inside or outside of a cigarette according to the shape of a heating element.

A cigarette may include a tobacco rod and a filter rod. The tobacco rod may be formed of sheets, strands, and tiny bits cut from a tobacco sheet. In addition, the tobacco rod may be surrounded by a heat conductive material. For example, the heat conductive material may be, but is not limited to, a metal foil such as aluminum foil.

The filter rod may include a cellulose acetate filter. The filter rod may include at least one segment. For example, the filter rod may include a first segment configured to cool aerosols, and a second segment configured to filter a certain component in aerosols.

In another embodiment, the aerosol generating device may be a device that generates aerosols by using a cartridge containing an aerosol generating material.

The aerosol generating device may include a cartridge containing an aerosol generating material and a main body supporting the cartridge. The cartridge may be coupled to the main body to be detachable, but embodiments are not limited thereto. The cartridge may be integrated with or assembled to the main body, and may be fixed so as not to be detached by a user. The cartridge may be coupled to the main body while accommodating aerosol generating material therein. But embodiments are not limited thereto, and the aerosol generating material may be inserted into the cartridge at a state where the cartridge is coupled to the main body.

The cartridge may contain an aerosol generating material in any one of various states such as a liquid state, a solid state, a gaseous state, or a gel state. The aerosol generating material may include a liquid composition. For example, the liquid composition may be a liquid including a tobacco-containing material having a volatile tobacco flavor component, or a liquid including a non-tobacco material.

The cartridge is operated by an electrical signal or a wireless signal transmitted from the main body to perform a function of generating aerosol by converting the phase of the aerosol generating material inside the cartridge to a gaseous phase. The aerosol may denote a gas in a state in which vaporized particles generated from the aerosol generating material and air are mixed.

In another embodiment, the aerosol generating device may generate aerosols by heating a liquid composition, and generated aerosols may be delivered to a user through a cigarette. That is, the aerosols generated from the liquid composition may move along an airflow passage of the aerosol generating device, and the airflow passage may be configured to allow aerosols to be delivered to a user by passing through a cigarette.

In another embodiment, the aerosol generating device may be a device that generates aerosols from an aerosol generating material by using an ultrasonic vibration method. In this case, the ultrasonic vibration method may refer to a method of generating an aerosol by atomizing an aerosol generating material by using ultrasonic vibration generated by a vibrator.

The aerosol generating device may include a vibrator, and the vibrator may generate a short period of vibration to atomize the aerosol generating material. The vibration generated by the vibrator may be an ultrasound vibration, and the frequency band of the ultrasound vibration may be about 100 kHz to about 3.5 MHz, but is not limited thereto.

The aerosol generating device may further include a wick that absorbs the aerosol generating material. For example, the wick may be arranged to wrap at least one area of the vibrator or to be in contact with at least one area of the vibrator.

As the voltage (e.g., AC voltage) is applied to the vibrator, heat and/or ultrasonic vibration may be generated from the vibrator, and the heat and/or ultrasonic vibration generated from the vibrator may be transmitted to the aerosol generating material absorbed into the wick. The aerosol generating material absorbed into the wick may be converted to a gas phase by heat and/or ultrasonic vibration transmitted from the vibrator, and as a result, aerosol may be generated.

For example, the viscosity of the aerosol generating material absorbed into the wick by the heat generated from the vibrator may be lowered, and the aerosol generating material of which the viscosity is lowered by the ultrasonic vibration generated from the vibrator may be divided into fine particles, thereby generating aerosol, but embodiments are not limited thereto.

In another embodiment, the aerosol generating device is a device that generates aerosols by heating an aerosol generating article accommodated in the aerosol generating device in an induction heating method.

The aerosol generating device may include a susceptor and a coil. In an embodiment, the coil may apply a magnetic field to the susceptor. As power is supplied to the coil from the aerosol generating device, a magnetic field may be formed inside the coil. In an embodiment, the susceptor may be a magnetic body that generates heat by an external magnetic field. As the susceptor is positioned inside the coil and a magnetic field is applied to the susceptor, the susceptor generates heat to heat an aerosol generating article. In addition, optionally, the susceptor may be positioned within the aerosol generating article.

In another embodiment, the aerosol generating device may further include a cradle.

The aerosol generating device may constitute a system with a separate cradle. For example, the cradle may be used to charge the battery of the aerosol generating device. Alternatively, the heater may be heated when the cradle is coupled to the aerosol generating device.

Hereinafter, the present disclosure will now be described more fully with reference to the accompanying drawings, in which exemplary embodiments of the present disclosure are shown such that one of ordinary skill in the art may easily work the present disclosure. The present disclosure may be implemented in the aerosol generating devices of various embodiments described above, or may be implemented in various different forms, and is not limited to the embodiments described herein.

Hereinafter, embodiments of the present disclosure will be described in detail with reference to the drawings.

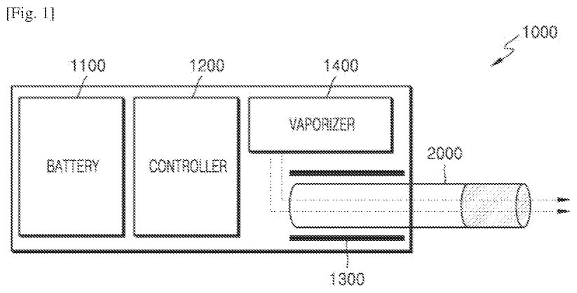

FIG. 1 is a view of an example of an aerosol generating device including a vaporizer, according to an embodiment.

Referring to FIG. 1, the aerosol generating device 1000 may include a battery 1100, a controller 1200, a heater 1300, and a vaporizer 1400.

The aerosol generating device 1000 of FIG. 1 may include a housing including an accommodating space in which the aerosol generating article 2000 is accommodated. The aerosol generating article 2000 may be inserted into the aerosol generating device 1000, and accordingly, the aerosol generating article 2000 may be accommodated in the accommodating space. Also, it is illustrated that the aerosol generating device 10000 includes the heater 1300, but the heater 1300 may be omitted when necessary.

FIG. 1 illustrates components of the aerosol generating device 1000, which are related to the embodiment. Also, general-purpose components other than the components illustrated in FIG. 1 may further be included in the aerosol generating device 1000.

FIG. 1 illustrates that the vaporizer 1400 and the heater 1300 are arranged in parallel. However, the internal structure of the aerosol generating device 1000 is not limited to the structure shown in FIG. 1. In other words, according to the design of the aerosol generating device 1000, the battery 1100, the controller 1200, the heater 1300, and the vaporizer 1400 may be differently arranged.

When the cigarette 2000 is inserted into the aerosol generating device 1000, the aerosol generating device 1000 may operate the heater 13 and/or the vaporizer 14 to generate an aerosol. The aerosol generated by the heater 1300 and/or the vaporizer 1400 may pass through the cigarette 2000 to be delivered to the user.

According to necessity, even when the cigarette 2000 is not inserted into the aerosol generating device 1000, the aerosol generating device 1000 may heat the heater 1300.

The battery 1100 may supply power to be used for operation of the aerosol generating device 1000. For example, the battery 1100 may supply power to heat the heater 1300 or the vaporizer 1400, and may supply power for operation of the controller 1200. Also, the battery 1100 may supply power for operation of a display, a sensor, a motor, etc. mounted in the aerosol generating device 1000.

The controller 1200 may generally control operations of the aerosol generating device 1000. In detail, the controller 1200 may not only control operations of the battery 1100, the heater 1300, and the vaporizer 1400, but also operations of other components included in the aerosol generating device 1000. Also, the controller 1200 may check a state of each of the components of the aerosol generating device 1000 to determine whether or not the aerosol generating device 1000 is able to operate.

The controller 1200 may include at least one processor. A processor may be implemented as an array of a plurality of logic gates or may be implemented as a combination of a general-purpose microprocessor and a memory in which a program executable in the microprocessor is stored. It will be understood by one of ordinary skill in the art that the processor can be implemented in other forms of hardware.

The heater 1300 may be heated by the power supplied from the battery 1100. For example, when the aerosol generating article 2000 is inserted into the aerosol generating device 1000, the heater 1300 may be located outside the aerosol generating article 2000. Thus, the heated heater 1300 may increase a temperature of an aerosol generating material in the aerosol generating article 2000.

The heater 1300 may include an electro-resistive heater. For example, the heater 1300 may include an electrically conductive track, and the heater 1300 may be heated when currents flow through the electrically conductive track. However, the heater 1300 is not limited to the example described above and may include all heaters which may be heated to a desired temperature. Here, the desired temperature may be pre-set in the aerosol generating device 1000 or may be set as a temperature desired by a user.

As another example, the heater 1300 may include an induction heater. In detail, the heater 1300 may include an electrically conductive coil for heating an aerosol generating article in an induction heating method, and the aerosol generating article may include a susceptor which may be heated by the induction heater.

FIG. 1 illustrates that the heater 1300 is positioned outside the aerosol generating article 2000, but embodiments are not limited thereto. For example, the heater 1300 may include a tube-type heating element, a plate-type heating element, a needle-type heating element, or a rod-type heating element, and may heat the inside or the outside of the aerosol generating article 200, according to the shape of the heating element.

Also, the aerosol generating device 1000 may include a plurality of heaters 1300. Here, the plurality of heaters 1300 may be inserted into the aerosol generating article 2000 or may be arranged outside the aerosol generating article 2000. Also, some of the plurality of heaters 1300 may be inserted into the aerosol generating article 2000 and the others may be arranged outside the aerosol generating article 2000. Also, the shape of the heater 1300 may not be limited to the shape shown in FIG. 1 and may include various shapes.

The vaporizer 1400 may generate an aerosol by heating a liquid composition and the generated aerosol may pass through the cigarette 2000 to be delivered to a user. In other words, the aerosol generated via the vaporizer 1400 may move along an air flow passage of the aerosol generating device 1000 and the air flow passage may be configured such that the aerosol generated via the vaporizer 1400 passes through the cigarette 2000 to be delivered to the user.

The vaporizer 1400 may include a liquid storage, a liquid delivery element, and a heating element, but is not limited thereto. For example, the liquid storage, the liquid delivery element, and the heating element may be included in the aerosol generating device 1000 as independent modules.

The liquid storage may store the aerosol generating material. For example, the aerosol generating material may be a liquid including a tobacco-containing material having a volatile tobacco flavor component, or a liquid including a non-tobacco material. The liquid storage may be formed to be attached/detached to/from the vaporizer 1400 or may be formed integrally with the vaporizer 1400.

For example, the aerosol generating material may include water, solvents, ethanol, plant extracts, spices, flavorings, or vitamin mixtures. The spices may include menthol, peppermint, spearmint oil, and various fruit-flavored ingredients, but are not limited thereto. The flavorings may include ingredients capable of providing various flavors or tastes to a user. Vitamin mixtures may be a mixture of at least one of vitamin A, vitamin B, vitamin C, and vitamin E, but are not limited thereto. Also, the aerosol generating material may include an aerosol forming substance, such as glycerin and propylene glycol.

The liquid delivery element may deliver the aerosol generating material of the liquid storage to the heating element. For example, the liquid delivery element may be a wick such as cotton fiber, ceramic fiber, glass fiber, or porous ceramic, but is not limited thereto.

The heating element is an element for heating the aerosol generating material delivered by the liquid delivery element. For example, the heating element may be a metal heating wire, a metal hot plate, a ceramic heater, or the like, but is not limited thereto. In addition, the heating element may include a conductive filament such as nichrome wire and may be positioned as being wound around the liquid delivery element. The heating element may be heated by a current supply and may transfer heat to the aerosol generating material in contact with the heating element, thereby heating the aerosol generating material. Accordingly, an aerosol may be generated from the aerosol generating material.

The vaporizer 1400 may be referred to as, but not limited to, a cartomizer or an atomizer.

In an embodiment, the vaporizer 1400 is a cartridge that may be inserted into and detached from the aerosol generating device 1000. When the stored aerosol generating material is completely consumed, the vaporizer 1400 may be supplemented with a new aerosol generating material or replaced with another vaporizer 1400 in which the aerosol generating material is stored.

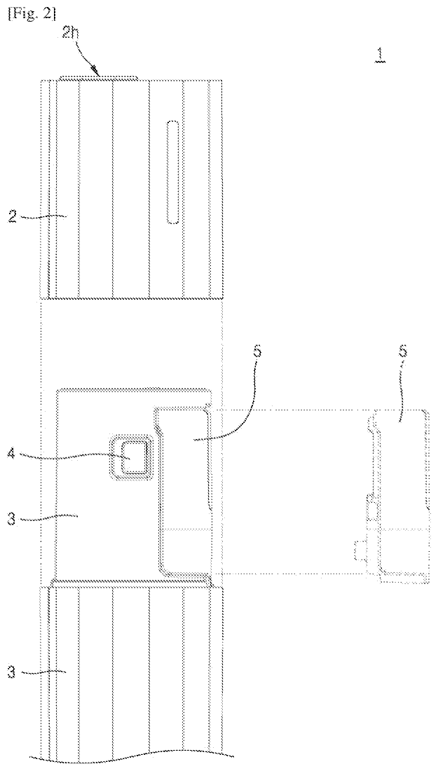

FIG. 2 is an exploded side view schematically illustrating an exterior shape of an aerosol generating device according to an embodiment.

Referring to FIG. 2, an aerosol generating device 1 according to an embodiment may include a cover 2, a main body 3, a button 4, and a vaporizer 5.

Here, the aerosol generating device 1 and the vaporizer 5 may respectively be the same as the aerosol generating device 1000 and the vaporizer 1400 of FIG. 1.

The cover 2 may be coupled to an end of the main body 3 so that the main body 3 and the cover 2 may together form the exterior of the aerosol generating device 1. An external hole 2h through which an aerosol generating article (not shown) may be inserted may be formed in an upper surface of the cover 2 coupled to the main body 3.

The main body 3 may form a portion of the exterior shape of the aerosol generating device 1 and may accommodate and protect components of the aerosol generating device 1. For example, a battery (not shown), a controller (not shown), and/or a heater (not shown) may be accommodated in the main body 3, but embodiments are not limited thereto. In addition, the main body 3 may accommodate the aerosol generating article inserted through the opening.

The main body 3 and the cover 2 may be formed of a plastic material with low conductivity, or a metal material, a surface of which is coated with a heat-blocking material. The main body 3 and the cover 2 may be, for example, formed by injection molding, three-dimensional (3D) printing, or assembling of small components formed by injection molding.

A maintaining device (not shown) for maintaining a coupling state of the main body 3 and the cover 2 may be formed between the main body 3 and the cover 2. The maintaining device may include, for example, a protrusion and a groove. The coupling state of the cover 2 and the main body 3 may be maintained by maintaining a state in which the protrusion is inserted into the groove, and the protrusion may be separated from the groove as the protrusion moves according to a manipulation button through which a user input is applied.

In addition, the maintaining device may include, for example, a magnet and a metal member attached to the magnet. When using a magnet in the maintaining device, the magnet may be mounted on any one of the main body 3 and the cover 2 and the metal member attached to the magnet may be mounted on the other one, or the magnet may be mounted on both the main body 3 and the cover 2.

Components of the aerosol generating device 1 are not limited to the above embodiments, and the aerosol generating device 1 according to another embodiment may not include the cover 2.

The cover 2 may be disconnected from the main body 3 to be separated from the main body 3. For example, the cover 2 may be separated from the main body 3 in a +2 direction. When the cover 2 is separated from the main body 3, the upper portion, the button 4, and the vaporizer 5 of the main body 3 may be exposed to the outside.

The button 4 may be arranged such that at least a portion of the button 4 is exposed to the outside of the main body 3, and according to a user's input, the button 4 may release the clamping relationship between the main body 3 and the vaporizer 5. For example, when a user input is applied to the button 4, the vaporizer 5 may be detached from the main body 3.

The vaporizer 5 may store an aerosol generating material and may be detachably coupled to one end of the main body 3.

In an embodiment, the vaporizer 5 may be coupled to the main body 3 including the controller and/or the battery and applied as a component of the aerosol generating device 1. For example, a heating element (not shown) included in the vaporizer 5 may be electrically connected to the main body 3, so that the heating element may receive power from the battery, and power supply to the heating element may be controlled by the controller.

That is, in the aerosol generating device including the vaporizer 5, power may be supplied to the heating element, and the supply of power to the heating element may be controlled, and thus, aerosol may be generated from the aerosol generating material in a liquid state or a gel state that is stored in the vaporizer 5.

In another example, the vaporizer 5 may be coupled to a housing (not shown) including an accommodating space (not shown) into which the aerosol generating article is accommodated and to the main body 3 including a heater for heating the aerosol generating article accommodated in the accommodating space.

That is, the aerosol generating device including the vaporizer 5 may not only generate an aerosol by heating the aerosol generating material stored in the vaporizer 5, but may also generate an aerosol by heating the inserted aerosol generating article. Accordingly, a hybrid type of aerosol generating device may be realized.

In FIG. 2, the vaporizer 5 is shown to be coupled to the main body 3 by being pushed towards the side of the main body 3, but the coupling method between the vaporizer 5 and the main body 3 is not limited thereto. For example, the vaporizer 5 may be coupled to the main body 3 by being pushed in the-z direction.

Hereinafter, for convenience of explanation, descriptions will be based on a structure in which the vaporizer 5 approaches and is coupled to the side of the main body 3.

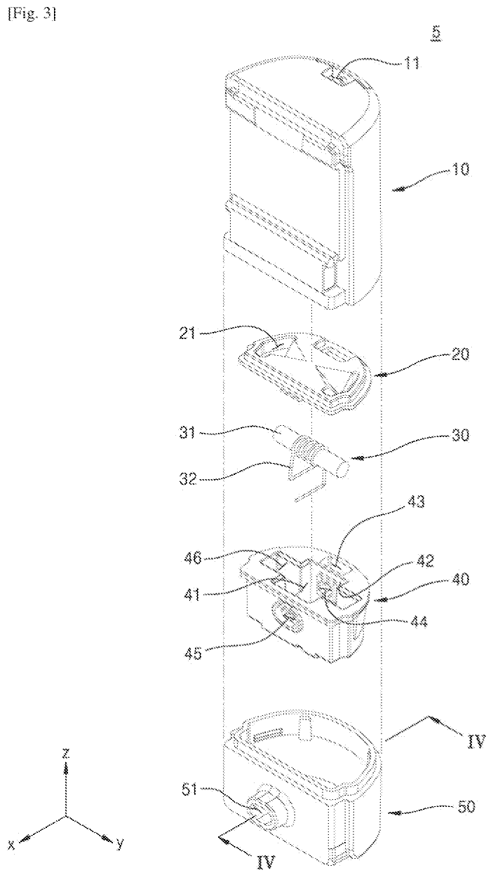

FIG. 3 is an exploded perspective view of a vaporizer according to an embodiment.

Referring to FIG. 3, the vaporizer 5 according to an embodiment may include a storage 10, a sealing unit 20, a generator 30, an accommodating unit 40, and a supporter 50.

Here, the storage 10 may be the same as the liquid storage included in the vaporizer 1400 of FIG. 1.

The storage 10, the sealing unit 20, the generator 30, the accommodating unit 40, and the supporter 50 may be coupled in the illustrated order. For example, the sealing unit 20 is coupled to the storage 10, the generator 30 is coupled to the accommodating unit 40, and the accommodating unit 40 is coupled to the supporter 50. Finally, the storage 10 and the supporter 50 may be coupled to each other to form the vaporizer 5.

The storage 10 forms a portion of the exterior of the vaporizer 5 and may store the aerosol generating material. The storage 10 may store an aerosol generating material in a liquid state or an aerosol generating material in a gel state. The aerosol generating material stored in the storage 10 may be delivered to the generator 30 arranged in the accommodating unit 40 and may be changed into an aerosol by the generator 30.

The storage unit 10 may include at least one outlet (not shown) through which the aerosol generating material moves. The outlet may be formed in at least a portion of the storage 10. For example, the outlet may be arranged in the top surface or the bottom surface of the storage 10 so that the aerosol generating material may be easily moved to outside the storage 10 by the action of gravity.

The storage 10 may include an inflow path 11 into which air outside the vaporizer 5 is introduced. The inflow path 11 may deliver air outside the vaporizer 5 to the accommodating unit 40.

The inflow path 11 may be arranged in the storage 10 and may not meet a space where the aerosol generating material is stored. Accordingly, in the storage 10 to the accommodating unit 40, the path through which the aerosol generating material is delivered and the path through which the air is delivered may be different. In addition, an end of the inflow path 11 adjacent to the accommodating unit 40 may be distinguished from the outlet.

The inflow path 11 may be formed between the storage 10 and other components coupled to the side of the storage 10, or may be formed inside the storage 10.

Referring to FIG. 3, the inflow path 11 may extend along the length direction (e.g. a z-axis direction) of the storage 10. However, embodiments are not limited to a particular arrangement of the inflow path.

The sealing unit 20 may prevent the leakage of the aerosol generating material. The sealing unit 20 may be coupled to at least a portion of the storage 10 to prevent the aerosol generating material stored in the storage 10 from leaking to the outside of the storage 10 through a gap other than the outlet.

The sealing unit 20 may be made of a material that is capable of being closely coupled to a portion of the storage 10. For example, the sealing unit 20 may be made of an elastic material such as rubber or silicone, but is not limited thereto.

The sealing unit 20 may be closely coupled to a portion of the storage 10 through which the inner space of the storage 10 is exposed to prevent the leakage of the aerosol generating material. In this case, the expression “closely coupled” may mean that the sealing unit 20 is firmly coupled to the storage 10 so that there is no gap through which the aerosol generating material leaks between the storage 10 and other components (e.g., between the storage 10 and the accommodating unit 40). The sealing unit 20 may be manufactured to be coupled to and separated from the storage 10, or may be manufactured integrally with the storage 10.

At least one discharge port 21 may be formed in at least one portion of the sealing unit 20 so that the aerosol generating material stored in the storage 10 moves outside the storage 10. For example, a portion or a surface of the storage 10 may be exposed to the outside, but as the sealing unit 20 in which the discharge port 21 is formed is coupled to a portion or a surface of the storage 10, the aerosol generating material stored in the storage 10 may be moved to the outside of the storage 10 through the discharge port 21 formed in the sealing unit 20.

The generator 30 may generate an aerosol from the aerosol generating material moved outside the storage 10. An aerosol indicates floating particles in which liquid and/or solid fine particles are dispersed in a gas. Therefore, the aerosol generated from the generator 30 may refer to a state in which vaporized particles generated from the aerosol generating material are mixed with air.

For example, the generator 30 may convert a phase of the aerosol generating material into a gas phase through vaporization and/or sublimation. In addition, the generator 30 may generate an aerosol by discharging the aerosol generating material in a liquid and/or solid phase into fine particles.

For example, the generator 30 may heat the aerosol generating material by generating heat. Accordingly, an aerosol may be generated from the aerosol generating material.

As another example, the generator 30 may generate an aerosol from an aerosol generating material by using ultrasonic vibration method. The ultrasonic vibration method may refer to a method of generating aerosol by atomizing an aerosol generating material with ultrasonic vibration generated by a vibrator.

*Hereinafter, for convenience of explanation, the generator 30 using a heating method will mainly be described.

Referring to FIG. 3, the generator 30 may include a wick 31 and a heating element 32.

Herein, the wick 31 and the heating element 32 may be identical to the liquid delivery element and heating element included in the vaporizer 1400 described in FIG. 1, respectively.

The wick 31 may receive the aerosol generating material supplied from the storage 10 and absorb the aerosol generating material. The wick 31 may have an elongate shape. For example, the wick 31 may have a columnar shape extending in one direction. Specifically, the wick 31 may have a polygonal columnar shape, such as a cylindrical shape, a quadrangular columnar shape, or a triangular columnar shape, but is not limited to thereto. For example, the wick 31 may have a rod shape or a needle shape.

A portion of the wick 31 may absorb an aerosol generating material received from the storage 10. For example, an aerosol generating material absorbed into a portion of the wick 31 may move to another portion of the wick 31 according to capillary action.

In an embodiment, the wick 31 absorbs the aerosol generating material received from the storage 10 through both ends thereof, and the absorbed aerosol generating material may move to the center of the wick 31.

The heating element 32 may heat the aerosol generating material absorbed in the wick 31 and generate an aerosol. The heating element 32 may be arranged adjacent the wick 31. For example, the heating element 32 may be a heating wire wound around the outer circumferential surface of a center portion of the wick 31. The heating element 32 may generate an aerosol by heating a liquid aerosol generating material delivered to the central portion of the wick 31.

The accommodating unit 40 may include a chamber 41 accommodating the generator 30. The chamber 41 may be a space wherein an aerosol is generated by the generator 30 accommodated in the chamber 41.

The accommodating unit 40 may include a plurality of walls 42 surrounding the chamber 41. The plurality of walls 42 may be a “chamber wall” to implement a space called the chamber 41.

The chamber 41 may be opened in a direction (e.g., a +z direction) facing the sealing unit 20 coupled to the accommodating unit 40. In this case, the open portion may not be arranged on the wall 42.

The accommodating unit 40 may include a flow path 43 through which air moves. The flow path 43 may be connected to the inflow path 11 of the storage 10 and accept air moved along the inflow path 11. The flow path 43 may deliver the accepted air to the chamber 41.

The flow path 43 may be bent or curved in the form of the alphabet ‘L’ and may extend lengthwise to a direction facing the chamber 41, the storage 10, and the sealing unit 20. However, embodiments are not limited to the shape of the flow path.

The accommodating unit 40 may include an inlet 44 to introduce air into the chamber 41 and an outlet 45 to discharge an aerosol generated by the generator 30 to outside the vaporizer 5.

The inlet 44 may be connected to an end of the flow path 43. Air moved along the inflow path 11 and the flow path 43 may be introduced into the chamber 41 through the inlet 44 included in at least a portion of the accommodating unit 40. The aerosol generated in the chamber 41 may be discharged outside the vaporizer 5 through the outlet 45 included in at least a portion of the accommodating unit 40.

The outlet 45 may be connected to the airflow path (not shown) of the body (e.g., the main body 3 of FIG. 2) of the aerosol generating device (e.g., the aerosol generating device 1 of FIG. 2). The aerosol generated in the vaporizer 5 may be introduced into the airflow path of the main body through the outlet 45. The aerosol may be delivered to aerosol generating article (not shown) accommodated in the accommodating space (not shown) through the airflow path of the main body.

The inlet 44 and the outlet 45 may be arranged in at least a portion of the plurality of walls 42 surrounding the chamber 41. Referring to FIG. 3, the inlet 44 and the outlet 45 are each arranged on the opposite walls 42 to face each other. However, embodiments are not limited to the arrangement of the inlet and the outlet.

The accommodating unit 40 may include an accommodating groove 46 for supporting the generator 30 and receiving the aerosol generating material from the storage 10.

The accommodating groove 46 may support at least a portion of the wick 31. In addition, the accommodating groove 46 may temporarily store the aerosol generating material moved outside the storage 10.

Referring to FIG. 3, two accommodating grooves 46 are arranged to support both ends of the wick 31, but embodiments are not limited to the number of the accommodating grooves 46.

The accommodating groove 46 may be connected to the chamber 41. The two accommodating grooves 46 may support both ends of the wick 31, and the chamber 41 arranged between the two accommodating grooves 46 may accommodate the center of the wick 31.

The accommodating unit 40 may be coupled to at least a portion of the sealing unit 20. The sealing unit 20 coupled to the accommodating unit 40 may form a cavity by covering the chamber 41 and the accommodating groove 46 open in a direction facing the sealing unit 20. At least a portion of the generator 30 may be located in the cavity. The cavity is a space surrounded by the accommodating unit 40 and the sealing unit 20, and may refer to a space in which at least a portion of the generator 30 is located. For example, the central portion of the wick 31 around which the heating element 32 is wound may be in the cavity, and thus, an aerosol may be generated in the cavity.

The supporter 50 accommodates the accommodating unit 40 and is coupled to the storage 10 to form an exterior of the vaporizer 5 with the storage 10.

The supporter 50 may include an outflow path 51 connected to the outlet 45 of the accommodating unit 40. A portion of the outflow path 51 may be inserted into the main body of the aerosol generating device. A portion of the outflow path 51 inserted in the main body may be connected to the airflow path of the main body.

The portion where the outflow path 51 is connected to the airflow path may be sealed. By sealing the outflow path 51 and the airflow path tightly, in a process wherein the aerosol moves from the outlet 45 to the airflow path through the outflow path 51, the aerosol may be prevented from leaking to a space other than the airflow path.

Hereinafter, with reference to FIG. 4, the airflow path formed in the vaporizer 5 will be described in detail.

FIG. 4 is a side cross-sectional view of a vaporizer according to an embodiment.

FIG. 4 is a cross-sectional view of a disassembled vaporizer shown in FIG. 3 and cut in a direction of IV-IV, and is a view for explaining the airflow path formed in the vaporizer.

Referring to FIG. 4, the vaporizer 5 according to an embodiment may include the storage 10, the sealing unit 20, the generator 30, the accommodating unit 40, and the supporter 50.

At least one of the components of the vaporizer 5 according to an embodiment may be the same as or similar to at least one of the components of the vaporizer 5 of FIG. 3. Hereinafter, overlapping descriptions are omitted. Reference numbers that are not described in FIG. 4 may be referred to in FIG. 3.

Inside the aerosol generating device (not shown), there is an airflow path for the aerosol generated from the vaporizer 5 and the aerosol generating article (not shown).

Through the airflow path, a first aerosol generated by heating or atomizing the aerosol generating material of the vaporizer 5 by the generator 30 may be mixed with the second aerosol generated by heating the aerosol generating article by the heater (not shown), and may be inhaled by the user.

Referring to FIG. 4, the airflow path may start from the inlet of the inflow path 11 of the storage 10.

Air from outside the vaporizer 5 may be introduced into the inflow path 11. The air may move along the inflow path 11 to reach the flow path 43 of the accommodating unit 40. The air that passed through the flow path 43 may reach the chamber 41.

The air that reached the chamber 41 may be mixed with vaporized particles generated from the aerosol generating material by the generator 30 to form the first aerosol and may pass through the outlet 45 and move outside the vaporizer 5.

Referring to FIG. 4, the plurality of walls 42 surrounding the chamber 41 may include a first sidewall 42-1, a second sidewall 42-2, and a floor wall 42-3. The inlet 44 may be arranged in the first sidewall 42-1, and the outlet 45 may be arranged in the second sidewall 42-2.

The first sidewall 42-1 and the second sidewall 42-2 may face each other. Therefore, the inlet 44 arranged in the first sidewall 42-1 may face the outlet 45 arranged in the second sidewall 42-2. Therefore, the airflow in the chamber 41 may be formed in the +x direction, which is a direction from the inlet 44 to the outlet 45.

However, because the air and the aerosol cannot pass through the generator 30 accommodated in the chamber 41, the air and the aerosol need to move along the surrounding of the generator 30. In addition, due to various factors such as the size and shape of the chamber 41 and the arrangement of the inlet 44, the airflow may be formed in the y-axis direction and/or the z-axis direction.

The vaporizer 5 may include a structure and a shape that helps the airflow to proceed smoothly along the airflow path. Examples of embodiments may remove a dead zone that may exist around the airflow path to implement such a structure and shape. Here, the “dead zone” may refer to area where the airflow is not formed.

In general, dead zones may be caused by changes in the shape of the boundary of the object. In detail, the airflow may be formed along the boundary of the object. If the shape of the boundary of the object abruptly changes in the direction crossing the direction of the airflow, the airflow may not flow along the changing shape of the boundary and may become turbulent. As a result, a dead zone may appear. As the shape of the boundary changes abruptly, an area where the dead zone appears may become greater.

Turbulence may occur in the dead zone. Turbulence may cause vortex and backflow to inhibit the airflow moving along the airflow path around the dead area. Accordingly, the speed of the airflow, the amount of airflow delivered to the user, and the amount of atomization may be reduced.

To remove the dead zone, it is necessary to remove the empty space where the dead zone appears. By filling the empty space with structure and shapes of components, the empty spaces may disappear.

For example, referring to FIG. 4, an edge of the lower portion of the sealing unit 20 may protrude towards the accommodating unit 40 to be coupled to the accommodating unit 40.

Due to the protrusion, a dead zone may appear in the lower portion of the sealing unit 20. To remove the dead zone, the sealing unit 20 may include a guide surface 22 in the lower portion of the sealing unit 20. In this case, the guide surface 22 may include a flat or curved surface.

The guide surface 22 may be arranged in the lower portion of the sealing unit 20 to guide the airflow introduced into the chamber 41 such that “the airflow towards the lower portion of the sealing unit 20 from the inlet 44” and “the airflow towards the outlet 45 from the lower portion of the sealing unit 20” do not turn abruptly.

Hereinafter, in order to remove the dead zone, various embodiments of the accommodating unit 40 of which the structure and shape are improved are described in detail.

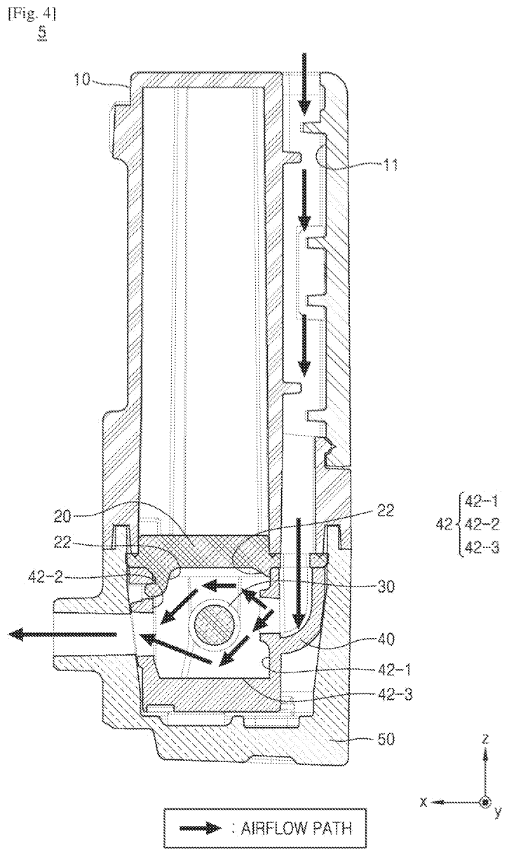

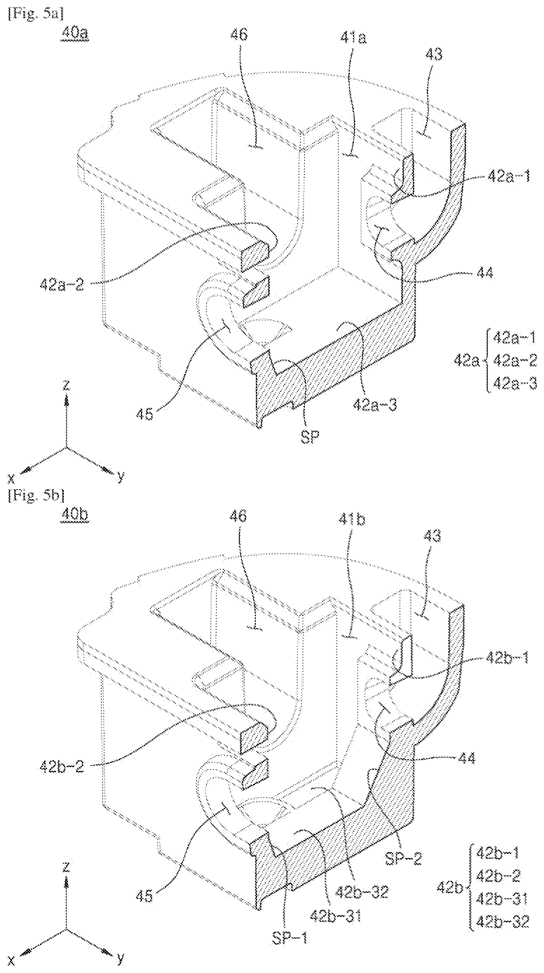

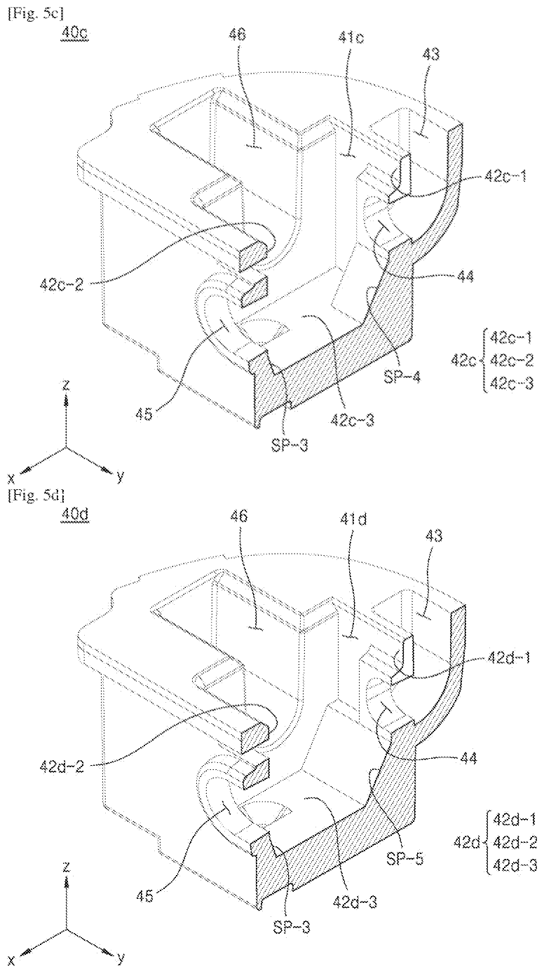

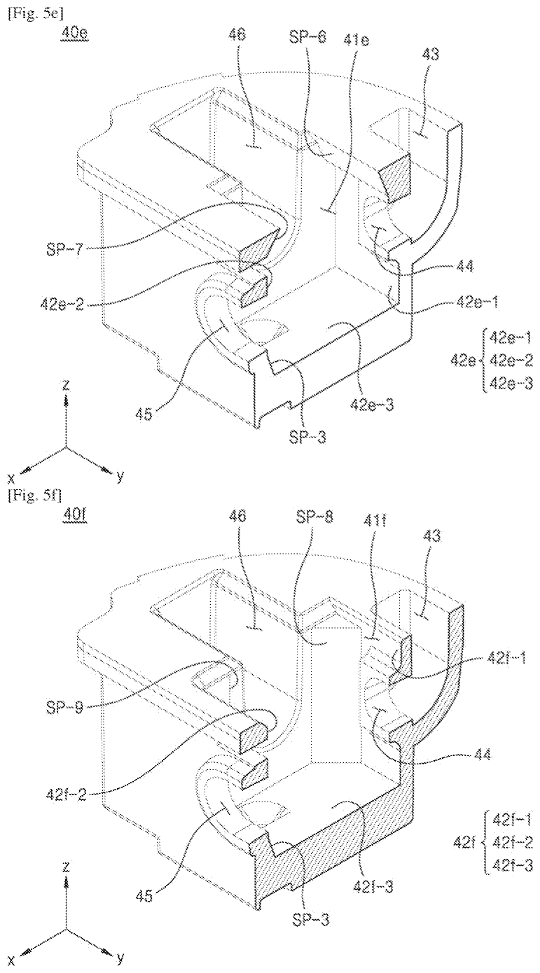

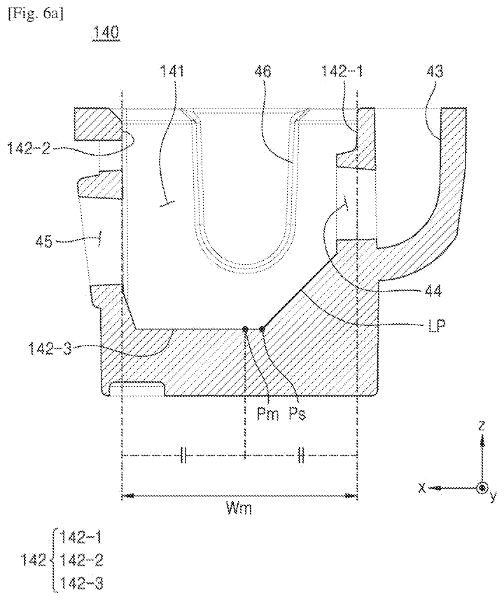

FIGS. 5A to 5F are each a perspective cross-sectional view of the accommodating unit of the vaporizer according to another embodiment.

FIGS. 5A to 5F are each a perspective cross-sectional view of the accommodating unit of the vaporizer cut in a IV-IV direction of FIG. 3 to explain the structure and shape of the plurality of walls surrounding the chamber of the accommodating unit. The illustrated accommodating unit may be symmetrical with respect to the cross section.

Referring to FIGS. 5A to 5F, like the accommodating unit 40 of the vaporizer 5 according to an embodiment, each embodiment may include the flow path 43, the inlet 44, the outlet 45, and the accommodating groove 46.

In addition, the embodiments are common in that the plurality of walls may include a first sidewall, a second sidewall, and a floor wall, the inlet 44 may be arranged in the first sidewall, and the outlet 45 may be arranged in the second sidewall in common. At least some of the plurality of walls may include inclined surfaces SP.

Here, “inclined surface” may refer to a slanted surface. The “reference surface,” which is referred to when determining a degree of inclination of an inclined surface, may be a surface of a second wall different from a first wall that includes the inclined surface. Alternatively, the first wall may include each of the reference surface and the inclined surface.

The “inclined surface” includes all inclined surfaces. Therefore, the “inclined surface” does not only refer to an inclined surface inclined in a straight line and consisting of a flat surface, but also refers to an inclined surface inclined in a curve and consisting of a curved surface.

At least some of the plurality of walls include inclined surfaces SP, and thus, in each embodiment, an inclined surface may be commonly arranged in the chamber. In the chamber, the dead zone is usually arranged adjacent to a corner arranged in a direction crossing the direction of the airflow. In this case, the “corner” may be formed by two intersecting walls among the plurality of walls surrounding the chamber.

In order to remove an empty space where the dead zone appears in the chamber, the inclined surface SP may be arranged at an intersection of two walls.

Hereinafter, based on differences between different embodiments, the chambers, the plurality of walls, and the inclined surfaces having different structures and shapes according to embodiments will be described.

Referring to FIG. 5A, an accommodating unit 40a may include a plurality of walls 42a surrounding a chamber 41a. The plurality of walls 42a may include a first sidewall 42a-1, a second sidewall 42a-2, and a floor wall 42a-3.

The inclined surface SP may be arranged at an intersection of the second sidewall 42a-2 and the floor wall 42a-3. In this case, the inclined surface SP may be seen as being included in the second sidewall 42a-2 and may also be seen as being included in the floor wall 42a-3.

Referring to FIG. 5B, an accommodating unit 40b may include a plurality of walls 42b surrounding a chamber 41b. The plurality of walls 42b may include a first sidewall 42b-1, a second sidewall 42b-2, and a first floor wall 42b-31, and a second floor wall 42b-32.

Unlike the accommodating unit 40a of FIG. 5A including one floor wall 42a-3, the accommodating unit 40b of FIG. 5B includes two floor walls 42b-31 and 42b-32, and the first floor wall 42b-31 protrudes in the +z direction compared to the second floor wall 42b-32. However, embodiments are not limited to the number of the floor walls and the extent to which the floor wall protrudes.

A first inclined surface SP-1 may be arranged at an intersection of the second sidewall 42b-2 and the first floor wall 42b-31. In this case, the first inclined surface SP-1 may be seen as being included in the second sidewall 42b-2 and may also be seen as being included in the first floor wall 42b-31.

A second inclined surface SP-2 may be arranged at an intersection of the first sidewall 42b-1 and the first floor wall 42a-31. In this case, the second inclined surface SP-2 may be seen as being included in the first sidewall 42a-1 and may also be seen as being included in the first floor wall 42b-31.

Referring to FIG. 5C, an accommodating unit 40c may include a plurality of walls 42c surrounding a chamber 41c. The plurality of walls 42c may include a first sidewall 42c-1, a second sidewall 42c-2, and a floor wall 42c-3.

Unlike the accommodating unit 40a of FIG. 5A including one inclined surface SP, the accommodating unit 40c of FIG. 5C includes two inclined surfaces SP-3 and SP-4. However, embodiments are not limited to the number of the inclined surfaces.

The third inclined surface SP-3 may be arranged identically to the inclined surface SP of FIG. 5A. That is, the third inclined surface SP-3 may have the same inclusion relation as the inclined surface SP shown in FIG. 5A with respect to the second wall 42c-2 and the floor wall 42c-3.

A fourth inclined surface SP-4 may be arranged at an intersection of the first sidewall 42c-1 and the floor wall 42c-3. In this case, the second inclined surface SP-4 may be seen as being included in the first sidewall 42c-1 and may also be seen as being included in the floor wall 42c-3.

Referring to FIG. 5D, an accommodating unit 40d may include a plurality of walls 42d surrounding a chamber 41d. The plurality of walls 42d may include a first sidewall 42d-1, a second sidewall 42d-2, and a floor wall 42d-3.

Unlike the fourth inclined surface SP-4 shown in FIG. 5C, which has the same width (e.g., a dimension in the y axis direction) as the protruding portion of the first sidewall 42c-1 including the inlet 44, the fifth inclined surface SP-5 shown in FIG. 5D is arranged throughout the whole area of an intersection of the first sidewall 42d-1 and the floor wall 42d-3. However, embodiments are not limited to the width of the inclined surfaces.

The third inclined surface SP-3 may be arranged identically to the inclined surface SP of FIG. 5A. That is, the third inclined surface SP-3 may have the same inclusion relation as the inclined surface SP shown in FIG. 5A with respect to the second wall 42d-2 and the floor wall 42d-3.

The fifth inclined surface SP-5 may be arranged at an intersection of the first sidewall 42d-1 and the floor wall 42d-3. In this case, the fifth inclined surface SP-5 may be seen as being included in the first sidewall 42d-1 and may also be seen as being included in the floor wall 42d-3.

Referring to FIG. 5E, an accommodating unit 40e may include a plurality of walls 42e surrounding a chamber 41e. The plurality of walls 42e may include a first sidewall 42e-1, a second sidewall 42e-2, and a floor wall 42e-3.

Unlike the third inclined surface SP-3 and the fifth inclined surface SP-5 of FIG. 5D, which are arranged at an interface of the two sidewalls 42d-1 and 42d-2 and the floor wall 42d-3, the sixth inclined surface SP-6 and the seventh inclined surface SP-7 of FIG. 5E may be arranged on the upper portion of the two sidewalls 42e-1 and 42e-2. In this case, the “upper portion of the two sidewalls” may refer to portions of the two sidewalls 42e-1 and 42e-2 adjacent to the top surface of the accommodating unit 40e which faces the +z direction and comes in contact with the sealing unit (not shown). However, embodiments are not limited to the arrangement of the inclined surface.

The third inclined surface SP-3 may be arranged identically to the inclined surface SP of FIG. 5A. That is, the third inclined surface SP-3 may have the same inclusion relation as the inclined surface SP shown in FIG. 5A with respect to the second wall 42e-2 and the floor wall 42e-3.

The sixth inclined surface SP-6 may be arranged on the upper portion of the first sidewall 42e-1. In this case, the sixth inclined surface SP-6 may be seen as being included in the first sidewall 42e-1.

The seventh inclined surface SP-7 may be arranged on the upper portion of the second sidewall 42ₑ-2. In this case, the seventh inclined surface SP-7 may be seen as being included in the second sidewall 42ₑ-2.

Referring to FIG. 5F, an accommodating unit 40f may include a plurality of walls 42f surrounding a chamber 41f. The plurality of walls 42f may include a first sidewall 42f-1, a second sidewall 42f-2, and a floor wall 42f-3.

Unlike the third inclined surface SP-3 and the fifth inclined surface SP-5 of FIG. 5D, which are arranged at an intersection of the two sidewalls 42d-1 and 42d-2 and the floor wall 42d-3, and extend in the y-axis direction, an eighth inclined surface SP-8 and a ninth inclined surface SP-9 of FIG. 5F are arranged in an intersection of the two sidewalls 42d-1 and 42d-2 and a wall connected to the accommodating groove 46, and extend in the z-axis direction. However, embodiments are not limited to the arrangement of the inclined surface and the extension direction of the inclined surface.

The third inclined surface SP-3 may be arranged identically to the inclined surface SP of FIG. 5A. That is, the third inclined surface SP-3 may have the same inclusion relation as the inclined surface SP shown in FIG. 5A with respect to the second wall 42f-2 and the floor wall 42f-3.

The eighth inclined surface SP-8 may be arranged at an intersection of the first sidewall 42f-1 and the wall connected to the accommodating groove 46. In this case, the eighth inclined surface SP-8 may be seen as being included in the first sidewall 42f-1 and may also be seen as being included in the wall connected to the accommodating groove 46.

The ninth inclined surface SP-9 may be arranged at an intersection of the second sidewall 42f-2 and the wall connected to the accommodating groove 46. In this case, the ninth inclined surface SP-9 may be seen as being included in the second sidewall 42f-2 and may also be seen as being included in the wall connected to the accommodating groove 46.

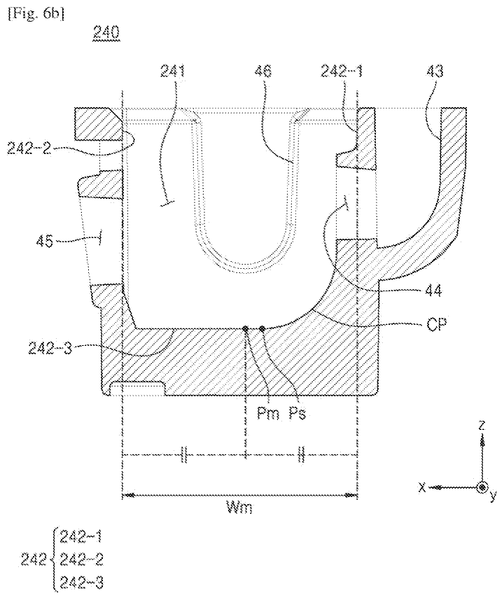

Hereinafter, with reference to FIGS. 6A and 6B, the shape of the inclined surface is described.

FIGS. 6A and 6B are each a side cross-sectional view of the accommodating unit of the vaporizer according to another embodiment.

FIGS. 6A and 6B are each a cross-sectional view of the accommodating unit of the vaporizer cut in a IV-IV direction of FIG. 3 to explain the shape of the inclined surface arranged on the chamber.

At least one of the components of the accommodating unit 140 of FIG. 6A and the accommodating unit 240 of FIG. 6B may be the same or similar to at least one of the components of the accommodating unit 40 of FIG. 3 and each of the accommodating units of FIGS. 5A to 5F. Therefore, overlapping descriptions will be omitted.

Referring to FIGS. 6A and 6B, the accommodating units 140 and 240 may include the plurality of walls 142 and 242 surrounding the chambers 141 and 241. The plurality of walls 142 and 242 may include the first sidewalls 142-1 and 242-1, the second sidewalls 142-2 and 242-2, and the floor walls 142-3 and 242-3.

The accommodating unit 140 shown in FIG. 6A and the accommodating unit 240 shown in FIG. 6B are different only in the shape of the inclined surfaces thereof. Therefore, the same portions are described through FIG. 6A.

Referring to FIG. 6A, the inclined surface (e.g., the second inclined surface SP-2 of FIG. 5B) may be arranged at the intersection of the first sidewall 142-1 and the floor wall 142-3. In this case, the inclined surface may be seen as being included in the sidewall 142-1 and may also be seen as being included in the floor wall 142-3.

The inclined surface shown in FIG. 6A may be an inclined surface LP inclined in a straight line and consisting of a flat surface, relative to the first sidewall 142-1 and the floor wall 142-3.

The inclined surface shown in FIG. 6B may be an inclined surface CP inclined in a curve and consisting of a curved surface, relative to the first sidewall 242-1 and the floor wall 242-3.

However, embodiments are not limited to arrangement of the inclined surfaces. As described with reference to FIGS. 5A to SF, the inclined surface is arranged in the chamber in various ways and may be included in at least some of the plurality of walls, and in which case the inclined surface may be made of a flat or curved surface.

Hereinafter, for convenience of explanation, descriptions will be made with reference to the floor wall. That is, the inclined surface will be described as being arranged at a portion of the floor wall, and the floor wall will be described as including the inclined surface connected to the first sidewall.

The “starting point of the inclination” and the “inclination angle” of the inclined surface LP arranged in the chamber 141 may differ according to the size of the chamber 141 and the arrangement of the inlet 44 and the outlet 45.

In order to explain the starting point of an inclination, a point Ps in the floor wall 142-3 where the inclined surface LP starts and a middle point Pm of a maximum width Wm of the chamber 141 may be compared. In this case, the “maximum width of the chamber” may refer to the maximum width WM of the chamber 141 in a direction (e.g. the x-axis direction) towards which the inlet 44 arranged in the first sidewall 142-1 is opened.

Referring to FIG. 6A, the point Ps where the inclined surface LP starts from the floor wall 142-3 may be closer to the inlet 44 than the middle point Pm of the maximum width Wm of the chamber 141.

Referring to FIG. 6B, the point Ps where the inclined surface CP starts from the floor wall 242-3 may be closer to the inlet 44 than the middle point Pm of the maximum width Wm of the chamber 241.

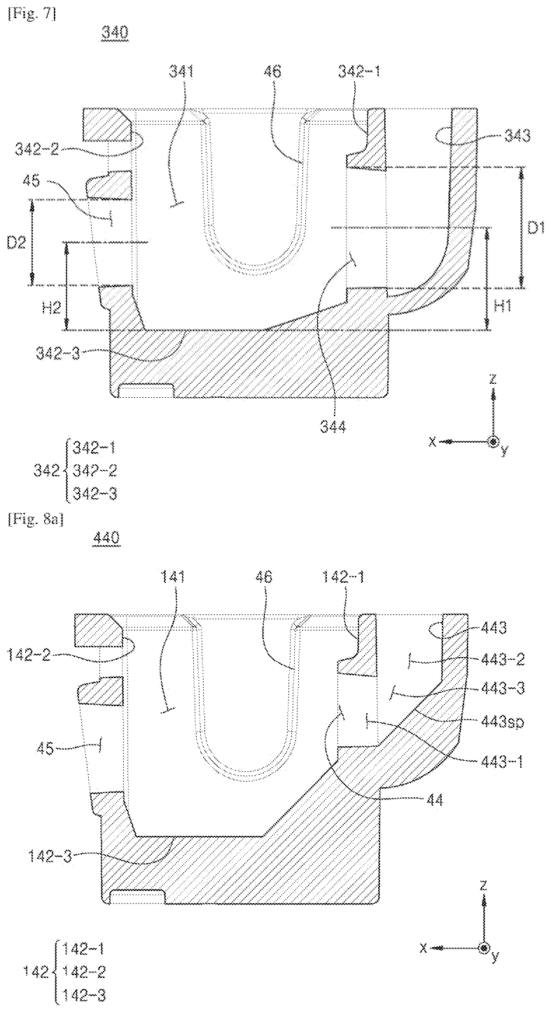

In order to remove the dead zone that appears inside the chamber, the size and arrangement of the inlet may be adjusted. Hereinafter, referring to FIG. 7, the size and arrangement of the inlet will be described in detail.

FIG. 7 is a side cross-sectional view of the accommodating unit of the vaporizer according to another embodiment.

FIG. 7 is a cross-sectional view of the accommodating unit of the vaporizer cut in the IV-IV direction of FIG. 3, according to another embodiment, and is a view for explaining the size and arrangement of the inlet to introduce air into the chamber.

At least one of the components of the accommodating unit 340 shown in FIG. 7 may be the same or similar to at least one of the components of the accommodating unit 40 shown in FIG. 3 and the accommodating unit 140 shown in FIG. 6A, and overlapping descriptions are omitted below.

Referring to FIG. 7, the accommodating unit 340 may include a plurality of walls 342 surrounding a chamber 341. The plurality of walls 342 may include a first sidewall 342-1, a second sidewall 342-2, and a floor wall 342-3. An inlet 344 may be arranged in the first sidewall 342-1, and the outlet 45 may be arranged in the second sidewall 342-2.

The inlet 344 of the accommodating unit 340 of FIG. 7 is larger than the inlet 44 of the accommodating unit 140 of FIG. 6A, and is arranged closer to the floor wall 342-3. Accordingly, a portion where the flow path 343 is connected to the inlet 344 of FIG. 7 is enlarged more than the portion where the flow path 43 is connected to the inlet 44 of FIG. 6A.

When the inlet 344 is arranged close to the floor wall 342-3 while the size of the inlet 344 is increased, the size of the dead zone at the intersection of the first sidewall 342-1 and the floor wall 342-3 may be decreased.

Apart from the effects of removing the dead zone, when the size of the inlet 344 is increased, more air may be introduced into the chamber 341 to increase the amount of smoke.

The inlet 344 arranged in the first side wall 342-1 may be arranged in a straight line with the generator (not shown) accommodated in the chamber 341 and the outlet 45 arranged in the second sidewall 342-2. The arrangement in a straight line may smoothen the airflow.

Accordingly, the inlet 344 not only needs to be great in size and close to the floor wall 342-3, but also needs to be arranged in a straight line with the generator and outlet 45. For this design, a correlation between the heights of and a correlation between the sizes of the inlet 344 and the outlet 45 may be determined. In this case, the ‘height’ may refer to a distance from the floor wall 342-3 toward a direction which the floor wall 342-3 faces.

Referring to FIG. 7, a height H1 of the center of the inlet 344 may be designed to be about 0.75 times to about 1.5 times a height H2 of the center of the outlet 45. In addition, a diameter D1 of the inlet 344 may be designed to be greater than or equal to a diameter D2 of the outlet 45.

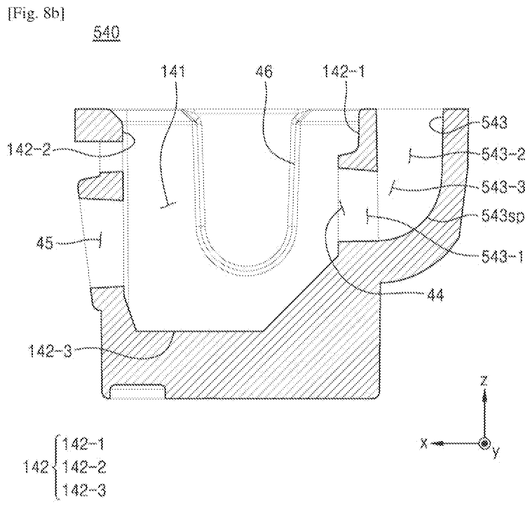

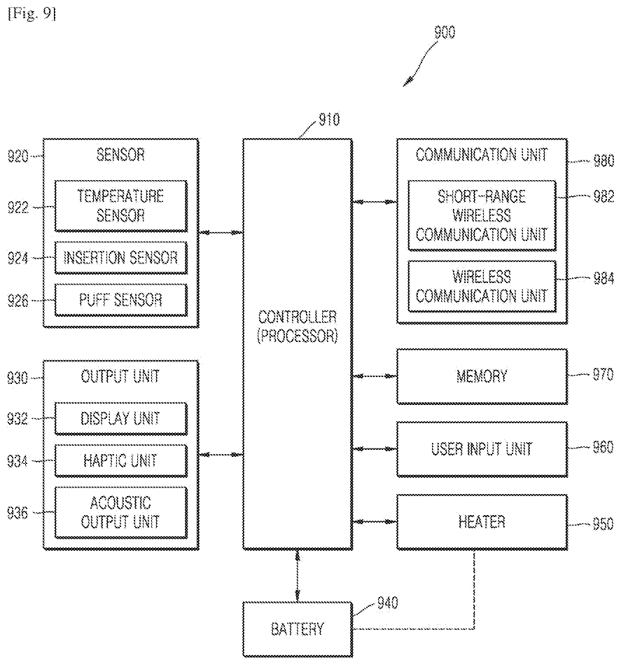

The dead zone may not only appear in the chamber but also in the flow path. Hereinafter, referring to FIGS. 8A and 8B, the shape of the flow path for removing the dead zone that appears in the flow path is described in detail.

FIGS. 8A and 8B are each a side cross-sectional view of the accommodating unit of the vaporizer according to another embodiment.

FIGS. 8A and 8B are each a cross-sectional view of the accommodating unit of the vaporizer cut in a IV-IV direction of FIG. 3 to explain the shape of the flow path.

At least one of the components of the accommodating unit 440 of FIG. 8A and the accommodating unit 540 of FIG. 8B may be the same or similar to at least one of the components of the accommodating unit 40 of FIG. 3 and the accommodating unit 140 of FIG. 6A. Therefore, overlapping descriptions will be omitted. Reference numbers that are not described in FIGS. 8A and 8B may be referred to in FIG. 3.

The accommodating unit 440 shown in FIG. 8A and the accommodating unit 540 shown in FIG. 8B are different only in the shape of the flow path thereof. Therefore, the same portions are described through FIG. 8A.

Referring to FIG. 8A, the flow path 443 is bent or curved in the shape of the alphabet ‘L,’ and extend in a direction toward the chamber 141 (e.g. the x-axis direction) and in a direction facing the storage 10 and the sealing unit 20 (e.g., the z-axis direction).

That is, the flow path 443 may include a first flow path 443-1 extending in a direction (e.g., the x-axis direction) in which the inlet 44 is opened to the chamber 141, and a second flow path 443-2 extending in a direction crossing a direction in which the first flow path 443-1 extends (i.e., the second flow path 443-2 extends in a direction in which the top surface of the accommodating unit 440 faces).

The flow path 443 may include a connecting flow path 443-3 connecting the first flow path 443-1 extending in the x-axis direction and the second flow path 443-2 extending in the z-axis direction to each other. The connecting flow path 443-3 may include a portion of the flow path 443 that is bent or curved.

In the above-described “bent or curved portion,” the airflow may not flow along the bent or curved shape and may become turbulent, thereby causing an appearance of the dead zone.

To remove the empty space where the dead zone appears from the flow path, a flow path surface 443sp guiding the airflow without abrupt change in shape may be arranged in the connecting flow path 443-3.

Referring to FIG. 8A, the connecting flow path 443-3 may include a flow path surface 443sp inclined in a straight line with respect to the direction in which the inlet 44 is opened. In this case, the flow path surface 443sp may be a flat surface inclined in a straight line with respect to the direction in which the top surface of the accommodating unit 440 faces.

Referring to FIG. 8B, like the flow path 443 of FIG. 5A, the flow path 543 of the accommodating unit 540 may include a first flow path 543-1, a second flow path 543-2, and a connecting flow path 543-3. The connecting flow path 543-3 may include a flow path surface 543sp inclined in a curve with respect to the direction in which the inlet 44 is opened. In this case, the flow path surface 543sp may be a curved surface inclined in a curve with respect to the direction in which the top surface of the accommodating unit 540 faces.

Referring to FIGS. 8A and 8B, the flow path surfaces 443sp and 543sp is illustrated only on the outer corner of the bent or curved portion, but embodiments are not limited to the arrangement of the flow path surface. For example, the flow path surface may also be arranged at the inner corner of the bent or curved portion.

FIG. 9 is a block diagram of an aerosol generating device according to another embodiment.

The aerosol generating device 900 may include a controller 910, a sensing unit 920, an output unit 930, a battery 940, a heater 950, a user input unit 960, a memory 970, and a communication unit 980. However, the internal structure of the aerosol generating device 900 is not limited to those illustrated in FIG. 9. In other words, according to the design of the aerosol generating device 900, it will be understood by one of ordinary skill in the art that some of the components shown in FIG. 9 may be omitted or new components may be added.

The sensing unit 920 may sense a state of the aerosol generating device 900 and a state around the aerosol generating device 900, and transmit sensed information to the controller 910. Based on the sensed information, the controller 910 may control the aerosol generating device 900 to perform various functions, such as controlling an operation of the heater 950, limiting smoking, determining whether an aerosol generating article (e.g., a cigarette, a cartridge, or the like) is inserted, displaying a notification, or the like.

The sensing unit 20 may include at least one of a temperature sensor 22, an insertion detection sensor 24, and a puff sensor 26, but is not limited thereto.

The temperature sensor 922 may sense a temperature at which the heater 950 (or an aerosol generating material) is heated. The aerosol generating device 900 may include a separate temperature sensor for sensing the temperature of the heater 950, or the heater 950 may serve as a temperature sensor. Alternatively, the temperature sensor 922 may also be arranged around the battery 940 to monitor the temperature of the battery 940.

The insertion detection sensor 924 may sense insertion and/or removal of an aerosol generating article. For example, the insertion detection sensor 924 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article.

The puff sensor 926 may sense a user's puff on the basis of various physical changes in an airflow passage or an airflow channel. For example, the puff sensor 926 may sense a user's puff on the basis of any one of a temperature change, a flow change, a voltage change, and a pressure change.

The sensing unit 920 may include, in addition to the temperature sensor 922, the insertion detection sensor 924, and the puff sensor 926 described above, at least one of a temperature/humidity sensor, a barometric pressure sensor, a magnetic sensor, an acceleration sensor, a gyroscope sensor, a location sensor (e.g., a global positioning system (GPS)), a proximity sensor, and a red-green-blue (RGB) sensor (illuminance sensor). Because the function of each sensor may be intuitively inferred from the name by one of ordinary skill in the art, the specific explanation may be omitted.

The output unit 930 may output information on a state of the aerosol generating device 900 and provide the information to a user. The output unit 930 may include at least one of a display unit 932, a haptic unit 934, and a sound output unit 936, but is not limited thereto. When the display unit 932 and a touch pad form a layered structure to form a touch screen, the display unit 932 may also be used as an input device in addition to an output device.

The display unit 932 may visually provide information about the aerosol generating device 900 to the user. For example, information about the aerosol generating device 900 may mean various pieces of information, such as a charging/discharging state of the battery 940 of the aerosol generating device 900, a preheating state of the heater 950, an insertion/removal state of an aerosol generating article, or a state in which the use of the aerosol generating device 900 is restricted (e.g., sensing of an abnormal object), or the like, and the display unit 932 may output the information to the outside. The display unit 932 may be, for example, a liquid crystal display panel (LCD), an organic light-emitting diode (OLED) display panel, or the like. In addition, the display unit 932 may be in the form of a light-emitting diode (LED) light-emitting device.

The haptic unit 934 may tactilely provide information about the aerosol generating device 900 to the user by converting an electrical signal into a mechanical stimulus or an electrical stimulus. For example, the haptic unit 934 may include a motor, a piezoelectric element, or an electrical stimulation device.

The sound output unit 936 may audibly provide information about the aerosol generating device 900 to the user. For example, the sound output unit 936 may convert an electrical signal into a sound signal and output the same to the outside.

The battery 940 may supply power used to operate the aerosol generating device 900. The battery 940 may supply power such that the heater 950 may be heated. In addition, the battery 940 may supply power required for operations of other components (e.g., the sensing unit 920, the output unit 930, the user input unit 960, the memory 970, and the communication unit 980) in the aerosol generating device 900. The battery 940 may be a rechargeable battery or a disposable battery. For example, the battery 940 may be a lithium polymer (LiPoly) battery, but is not limited thereto.

The heater 950 may receive power from the battery 940 to heat an aerosol generating material. Although not illustrated in FIG. 9, the aerosol generating device 900 may further include a power conversion circuit (e.g., a direct current (DC)/DC converter) that converts power of the battery 940 and supplies the same to the heater 950. In addition, when the aerosol generating device 900 generates aerosols in an induction heating method, the aerosol generating device 900 may further include a DC/alternating current (AC) that converts DC power of the battery 940 into AC power.

The controller 910, the sensing unit 920, the output unit 930, the user input unit 960, the memory 970, and the communication unit 980 may each receive power from the battery 940 to perform a function. Although not illustrated in FIG. 9, the aerosol generating device 900 may further include a power conversion circuit that converts power of the battery 940 to supply the power to respective components, for example, a low dropout (LDO) circuit, or a voltage regulator circuit.

In an embodiment, the heater 950 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, or nichrome, but is not limited thereto. In addition, the heater 950 may be implemented by a metal wire, a metal plate on which an electrically conductive track is arranged, a ceramic heating element, or the like, but is not limited thereto.

In another embodiment, the heater 950 may be a heater of an induction heating type. For example, the heater 950 may include a susceptor that heats an aerosol generating material by generating heat through a magnetic field applied by a coil.

The user input unit 960 may receive information input from the user or may output information to the user. For example, the user input unit 960 may include a key pad, a dome switch, a touch pad (a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. In addition, although not illustrated in FIG. 9, the aerosol generating device 900 may further include a connection interface, such as a universal serial bus (USB) interface, and may connect to other external devices through the connection interface, such as the USB interface, to transmit and receive information, or to charge the battery 940.

The memory 970 is a hardware component that stores various types of data processed in the aerosol generating device 900, and may store data processed and data to be processed by the controller 910. The memory 970 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 970 may store an operation time of the aerosol generating device 900, the maximum number of puffs, the current number of puffs, at least one temperature profile, data on a user's smoking pattern, and the like.

The communication unit 980 may include at least one component for communication with another electronic device. For example, the communication unit 980 may include a short-range wireless communication unit 982 and a wireless communication unit 984.

The short-range wireless communication unit 982 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra-wideband (UWB) communication unit, an Ant+ communication unit, or the like, but is not limited thereto.

The wireless communication unit 984 may include a cellular network communication unit, an Internet communication unit, a computer network (e.g., local area network (LAN) or wide area network (WAN)) communication unit, or the like, but is not limited thereto. The wireless communication unit 984 may also identify and authenticate the aerosol generating device 900 within a communication network by using subscriber information (e.g., International Mobile Subscriber Identifier (IMSI)).

The controller 910 may control general operations of the aerosol generating device 900. In an embodiment, the controller 910 may include at least one processor. A processor may be implemented as an array of a plurality of logic gates or may be implemented as a combination of a general-purpose microprocessor and a memory in which a program executable in the microprocessor is stored. It will be understood by one of ordinary skill in the art that the processor can be implemented in other forms of hardware.

The controller 910 may control the temperature of the heater 950 by controlling supply of power of the battery 940 to the heater 950. For example, the controller 910 may control power supply by controlling switching of a switching element between the battery 940 and the heater 950. In another example, a direct heating circuit may also control power supply to the heater 950 according to a control command of the controller 910.

The controller 910 may analyze a result sensed by the sensing unit 920 and control subsequent processes to be performed. For example, the controller 910 may control power supplied to the heater 950 to start or end an operation of the heater 950 on the basis of a result sensed by the sensing unit 920. As another example, the controller 910 may control, based on a result sensed by the sensing unit 920, an amount of power supplied to the heater 950 and the time the power is supplied, such that the heater 950 may be heated to a certain temperature or maintained at an appropriate temperature.

The controller 910 may control the output unit 930 on the basis of a result sensed by the sensing unit 920. For example, when the number of puffs counted through the puff sensor 926 reaches a preset number, the controller 910 may notify the user that the aerosol generating device 900 will soon be terminated through at least one of the display unit 932, the haptic unit 934, and the sound output unit 936.

One embodiment may also be implemented in the form of a computer-readable recording medium including instructions executable by a computer, such as a program module executable by the computer. The computer-readable recording medium may be any available medium that can be accessed by a computer and includes both volatile and nonvolatile media, and removable and non-removable media. In addition, the computer-readable recording medium may include both a computer storage medium and a communication medium. The computer storage medium includes all of volatile and nonvolatile, and removable and non-removable media implemented by any method or technology for storage of information such as computer-readable instructions, data structures, program modules or other data. The communication medium typically includes computer-readable instructions, data structures, other data in modulated data signals such as program modules, or other transmission mechanisms, and includes any information transfer media.

The descriptions of the above-described embodiments are merely examples, and it will be understood by one of ordinary skill in the art that various changes and equivalents thereof may be made. Therefore, the scope of the disclosure should be defined by the appended claims, and all differences within the scope equivalent to those described in the claims will be construed as being included in the scope of protection defined by the claims.

1. A vaporizer comprising:
a storage configured to store an aerosol generating material;
a generator configured to generate an aerosol from the aerosol generating material; and
an accommodating unit comprising a chamber configured to accommodate the generator, and an inlet configured to introduce air into the chamber,
wherein the accommodating unit comprises a plurality of walls surrounding the chamber, and at least some of the plurality of walls comprise an inclined surface.

2. The vaporizer of claim 1, wherein
the plurality of walls comprise a first sidewall which includes the inlet and the inclined surface, and
the inclined surface includes a flat or curved surface.

3. The vaporizer of claim 1, wherein
the plurality of walls comprise a floor wall,
the floor wall comprises the inclined surface, and
the inclined surface includes a flat or curved surface.

4. The vaporizer claim 3, wherein
the plurality of walls further comprise a first sidewall in which the inlet is arranged, and
the inclined surface is arranged where the floor wall meets the first sidewall.

5. The vaporizer of claim 3, wherein a point where the inclined surface starts from the floor wall is closer to the inlet than a middle point of a maximum width of the chamber, the width being measured in a direction in which the inlet is opened to the chamber.

6. The vaporizer of claim 1, wherein the accommodating unit further comprises an outlet configured to discharge the aerosol generated by the generator from the chamber to outside the vaporizer.

7. The vaporizer of claim 6, wherein
the plurality of walls further comprise a second sidewall in which the outlet is arranged, and
the second sidewall comprises the inclined surface, and the inclined surface comprises a flat or curved surface.

8. The vaporizer of claim 6, wherein
the plurality of walls further comprise the floor wall,
with respect to the floor wall, a height of a center of the inlet is about 0.75 times to about 1.5 times greater than a height of a center of the outlet, and
a diameter of the inlet is greater than or equal to a diameter of the outlet.

9. The vaporizer of claim 1, wherein the accommodating unit further comprises a flow path connected to the inlet and configured to receive air and deliver air to the chamber.

10. The vaporizer of claim 9, wherein the flow path comprises:
a first flow path extending in a direction in which the inlet is opened to the chamber; and
a second flow path extending in a direction crossing a direction in which the first flow path extends and opened in a direction in which a top surface of the accommodating unit faces.

11. The vaporizer of claim 10, wherein
the flow path further comprises a connecting flow path connecting the first flow path and the second flow path to each other, and
the connecting flow path comprises a flow path surface inclined in a straight line or in a curve with respect to a direction in which the inlet is opened to the chamber.

12. The vaporizer of claim 1, wherein the accommodating unit further comprises an accommodating groove configured to support the generator and receive the aerosol generating material from the storage.

13. The vaporizer of claim 1, wherein the storage comprises an inflow path configured to deliver air from outside of the vaporizer to the accommodating unit.

14. The vaporizer of claim 1, further comprising a sealing unit arranged between the storage and the accommodating unit,
wherein the sealing unit comprises a guide surface configured to guide movement of air introduced into the chamber.

15. An aerosol generating device comprising:
the vaporizer according to claim 1:
a main body comprising an accommodating space configured to accommodate an aerosol generating article and connected to the vaporizer;
a heater configured to heat the aerosol generating article accommodated in the main body;
a battery configured to supply power to the generator and the heater, and a controller configured to control power supplied to the generator and the heater.
